(19) United States
(12) Patent Application Publication
(10) Pub. No.: US 2007/0214650 A1
(43) Pub. Date: Sep. 20, 2007

(54) CONSTRUCTIVE DISPOSITION APPLIED TO SILVERWARE

(76) Inventor: Pedro Luiz TOMAZINI, Gramado/RS (BR)

Correspondence Address: OSTROLENK FABER GERB & SOFFEN, 1180 AVENUE OF THE AMERICAS, NEW YORK, NY, 100368403, US

(21) Appl. No.: 11/686,042

(22) Filed: Mar. 14, 2007

(30) Foreign Application Priority Data
Mar. 15, 2006 (BR) MU8600456-5

(51) Int. Cl. B26B 3/00

(52) U.S. Cl. 30/142; 30/147; 30/322; 30/324

(57) ABSTRACT

The present model of utility refers to a new constructive disposition applyed to any silverware, that is, knives, forks or spoons.

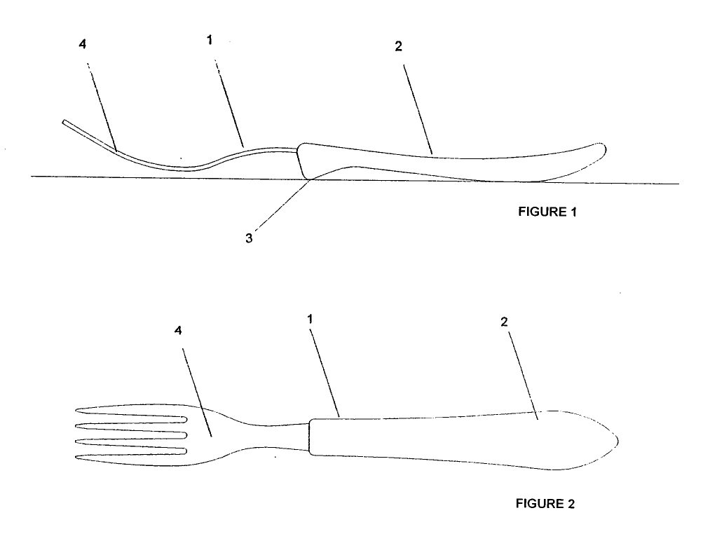

The objective of this model of utility includes any silverware (1), that is fork, spoon or knife, that has a handle (2) with a bump (3) in the point of union of the handle with the part that goes to the mouth of the user (4), allowing the silverware to remain distant from the resting surface, being, this way, more hygienic when used.

The present model of utility refers to a new constructive disposition applied to any silverware, that is, knives, forks and spoons.

The existing silverware present as an inconvenient the fact that they are always in contact with not always cleaned and well hygienized surfaces. These instruments are used in hospitals, homes, bars, restaurants and the risk of contamination by agents that can be harmfull to human health is huge.

The objective of this present model of utility is to efficiently solve this limitation existing in the silverware present in the market. This is possible due to a handle with a geometry capable of avoiding the parts that go to the mouth having contact with surfaces. Avoiding this risk of contamination, the silverware offers higher hygienization when used. The proposed silverware has a bump in the point that joins the handle with the part that goes to the mouth of the user, avoiding, this way, its contact with surfaces.

In order to facilitate the understanding of the present model of utility, it will be described in details based in the following drawings:
Picture 1—side sight of the proposed silverware;
Picture 2—up sight of the proposed silverware.

Pictures 1 and 2 illustrate the disposition introduced in the silverware, that can be any silverware (1), including fork, spoon or knife, that has a handle (2) with a bump (3) in the point of union of the handle with the part that goes to the mouth of the user (4), allowing the silverware to remain distant from the resting surface, being, this way, more hygienic when used.

1. “CONSTRUCTIVE DISPOSITION APPLIED TO SILVERWARE”, characterized by applying to any silverware (1), including fork, spoon or knife, that has a handle (2) with a bump (3) in the point of union of the handle with the part that goes to the mouth of the user (4), allowing the silverware to remain distant from the resting surface, being, this way, more hygienic when used.
